(19) United States
(12) Patent Application Publication
(10) Pub. No.: US 2005/0259024 A1
(43) Pub. Date: Nov. 24, 2005

(54) Multi-band antenna with wide bandwidth

(75) Inventors: Chen-Ta Hung, Tu-chen (TW); Lung-Sheng Tai, Tu-Chen (TW); Hsien Chu Lin, Tu-chen (TW); Yun-Lung Ke, Tu-chen (TW)

Correspondence Address: WEI TE CHUNG;FOXCONN INTERNATIONAL, INC., 1650 MEMOREX DRIVE, SANTA CLARA, CA, 95050, US

(73) Assignee: HON HAI PRECISION IND. CO., LTD.

(21) Appl. No.: 11/026,601

(22) Filed: Dec. 30, 2004

(30) Foreign Application Priority Data
May 24, 2004 (TW) 93114591

(51) Int. Cl. H01Q 13/10

(52) U.S. Cl. 343/770; 343/702

(57) ABSTRACT

A multi-band antenna (100) used in wireless communications includes a first radiating patch (20) arranged in a first plane and extending in a first direction, a second radiating patch (22) arranged in the first plane and extending in a second direction different from the first direction, a grounding portion (1) arranged in second plane parallel to the first plane, and an inverted F-shaped connecting portion (3) connecting the first and the second radiating patches and the grounding portion. The radiating patches define a plurality of slots (201, 202) for increasing a bandwidth of the antenna. The connecting portion defines a rectangular slot (35) for adjusting an impedance matching of the antenna.

### BACKGROUND OF THE INVENTION

1. Field of the Invention

The present invention relates generally to an antenna, and more particularly to a multi-band antenna used in an electronic device.

2. Description of the Prior Art

In recent years, portable wireless communication devices are becoming increasingly popular. For the design of the wireless communication device, an antenna used with it for transmitting and receiving electromagnetic waves is an important factor should be taken into account. The antenna may be mounted out of or in the device. In general use, the antenna is built-in arranged to save space and increase convenience. Considering the miniaturization trend of the wireless communication devices, the size of the antenna should be accompanylingly reduced in order to be assembled in the limit space of the communication device.

Moreover, among present wireless technologies, Bluetooth running in 2.4 GHz, IEEE 802.11b/g running in 2.4 GHz and IEEE 802.11a running in 5 GHz are prevailing and dominant. In response to the wide applications of the frequency, there is an increasing demand to make one communication device to support two or more frequencies.

To make the miniaturized antenna supporting two or more working frequencies becomes a hot R&D issue. Many antennas have been developed in prior arts to address the issue, such as microstrip antennas, antennas with high dielectric constant, planar inverted-F antennas, combinations of loop antenna and slot antenna, small size patch antennas and the like.

A multi-band antenna embedded within a radio communication device is disclosed in U.S. Pat. No. 6,166,694. The conventional antenna comprises a dielectric substrate 320, two spiral arms 305, 310 printed on the dielectric substrate 320 and respectively tuned to a lower and a higher frequency bands and a matching bridge 330 connected to the spiral arms 305, 310. Referring to FIG. 5 of this prior art, a loading resistor 560 is attached to the matching bridge 330 for enhancing a bandwidth of the antenna. However, the dielectric substrate of the antenna will introduce insertion loss, which adversely affects the antenna gain. Additionally, though adding the loading resistor 560 can enhancing the bandwidth of the lower and the higher frequency bands, the bandwidth is still not wide enough, which restrains the application of the antenna.

Hence, in this art, a multi-band antenna with wide bandwidth to overcome the above-mentioned disadvantages of the prior art will be described in detail in the following embodiment.

### BRIEF SUMMARY OF THE INVENTION

A primary object, therefore, of the present invention is to provide a multi-band antenna with wide bandwidth and compact configuration, and with easily tuned bandwidth and impedance matching.

In order to implement the above object and overcomes the above-identified deficiencies in the prior art, the multi-band antenna comprises a first radiating patch arranged in a first plane and extending in a first direction, a second radiating patch arranged in the first plane and extending in a second direction different from the first direction, a grounding portion arranged in second plane parallel to the first plane, and an inverted F-shaped connecting portion arranged in a third plane perpendicular to the first plane and connecting the first and the second radiating patches and the grounding portion. The radiating patches define a plurality of slots for increasing a bandwidth of the antenna. The connecting portion defines a rectangular slot for adjusting an impedance matching of the antenna.

Other objects, advantages and novel features of the invention will become more apparent from the following detailed description of a preferred embodiment when taken in conjunction with the accompanying drawings.

### BRIEF DESCRIPTION OF THE DRAWINGS

FIG. 1 is a perspective view of a multi-band antenna in accordance with the present invention.

FIG. 2 is a top view of the multi-band antenna in accordance with the present invention.

FIG. 3 is a test chart recording of Voltage Standing Wave Ratio (VSWR) of the dual-band antenna as a function of frequency.

FIG. 4 is a horizontally polarized principle plane radiation pattern of the antenna operating at the resonant frequency of 2.45 GHz.

FIG. 5 is a vertically polarized principle plane radiation pattern of the antenna operating at the resonant frequency of 2.45 GHz.

FIG. 6 is a horizontally polarized principle plane radiation pattern of the antenna operating at the resonant frequency of 5.25 GHz.

FIG. 7 is a vertically polarized principle plane radiation pattern of the antenna operating at the resonant frequency of 5.25 GHz.

FIG. 8 is a horizontally polarized principle plane radiation pattern of the antenna operating at the resonant frequency of 5.598 GHz.

FIG. 9 is a vertically polarized principle plane radiation pattern of the antenna operating at the resonant frequency of 5.598 GHz.

### DETAILED DESCRIPTION OF THE INVENTION

Reference will now be made in detail to a preferred embodiment of the present invention.

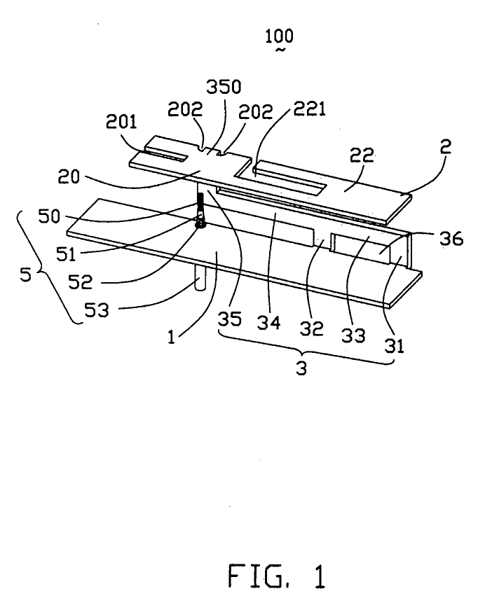

Referring to FIG. 1, a multi-band antenna 100 according to the present invention is made of metal sheet and comprises a grounding portion 1 arranged in a first plane, a radiating portion 2 arranged in a second plane parallel to the first plane and a connecting portion 3 arranged in a third plane perpendicular to the first plane and connecting the grounding portion 1 and the radiating portion 2. A feeder cable 5 is provided for feeding the antenna 100.

The connecting portion 3 is substantially inverted F-shaped and comprises a first, a second, a third, a fourth and a fifth connecting sections 31, 32, 33, 34 and 35. The first and the second connecting sections 31, 32 upwardly and vertically extend from a same side of the grounding portion 1. The third connecting section 33 connects with the first and the second connecting sections 31, 32 and is parallel to the grounding portion 1. The fourth connecting section 34 is aligned with the third connecting section 33 and extends from an end of the third connecting section 32. The fifth connecting section 35 upwardly and vertically extends from an end of the fourth connecting section 34 and terminates to the radiating portion 2. The fifth connecting section 35 and the radiating portion 2 form a conjunction 350. The first, the second and the third connecting sections 31, 32 and 33 together form an n-shaped configuration with a rectangular slot 36 defining therein which is provided for tuning an input impedance of the antenna 100 so as to realize impedance matching between the antenna 100 and the feeder cable 5.

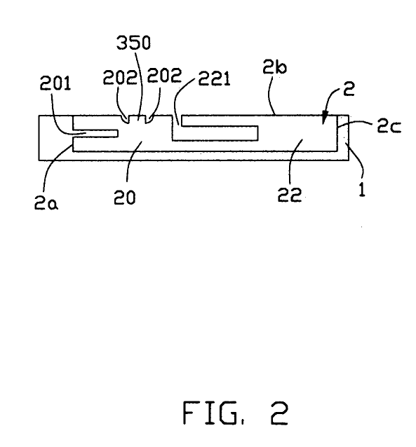

The radiating portion 2 is formed into a substantially rectangular shape and comprises a first radiating patch 20 and a second radiating patch 22 extending in opposite directions from the conjunction 350. The first and the second radiating patches 20, 22 have the same width and different lengths. As best shown in FIG. 2, the radiating portion 2 has a first edge 2a, a second edge 2b adjacent and perpendicular to the first edge 2a and a third edge 2c adjacent to the second edge 2b and opposite to and parallel to the first edge 2a. The first radiating patch 20 defines a first elongated slot 201 inwardly extending from the first edge 2a. An open end of the first slot 201 is arranged on a central position of a width of the first edge 2a and a close end of the first slot 201 is adjacent to the conjunction 350. A width of the first elongated slot 201 is much narrower than that of the first radiating patch 20. The first and the second radiating patches 20, 22 respectively define a second arc slot 202 inwardly extending from the second edge 2b and positioned at two sides of the conjunction 350. The pair of arc slots 202 are both formed in configuration of a quarter of a circle and are arranged at an interval of a semidiameter of said circle. The semidiameter of the circle is much smaller than the width of the radiating portion 2. The second radiating patch 22 further defines a third L-shaped slot 221 adjacent to the conjunction 350. The L-shaped slot 221 extends from the second edge 2b and faces to the third edge 2c. The arc slots 202 are arranged between the elongated slot 201 and the L-shaped slot 221.

The feeder cable 5 is a coaxial cable and successively comprises an inner conductor 50, an inner insulator 51, an outer conductor 52 and an outer insulator 53. A feeder point is arranged on the fifth connection section 35. The inner conductor 50 is electrically connected with the feeder point. The outer conductor 52 is electrically connected with the grounding portion 1.

The first radiating patch 20, the connecting portion 3, the feeder cable 5 and the grounding portion 1 corporately form a first inverted-F antenna operating at a higher frequency bands of about 5.2 GHz and 5.75 GHz. The second radiating patch 22, the connecting portion 3, the feeder cable 5 and the grounding portion 1 corporately form a second inverted-F antenna operating at a lower frequency band of about 2.4 GHz. Defining the first slot 201 and the second slots 202 can increase the bandwidth of the first inverted-F antenna. Defining the third slot 221 helps decrease the dimension of the second inverted-F antenna.

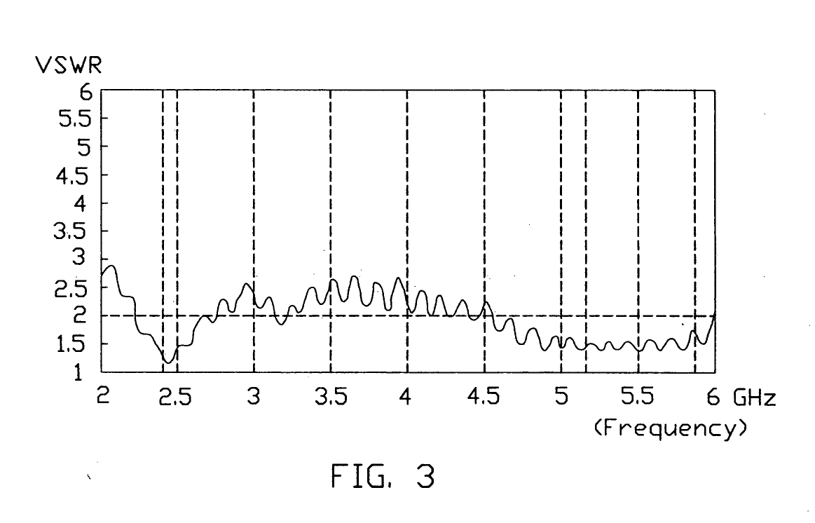

In terms of this preferred embodiment, the performance of the antenna 100 is excellent. In order to illustrate the effectiveness of the present invention, FIG. 3 sets forth a test chart recording of Voltage Standing Wave Ratio (VSWR) of the dual-band antenna 100 as a function of frequency. Note that VSWR drops below the desirable maximum value “2” in the 2.4-2.5 GHz frequency band which covers the bandwidth of wireless communications under Bluetooth and IEEE 802.11b/g standard, and 5.15-5.85 GHz, indicating a wide bandwidth of 700 MHz, which covers the bandwidth of wireless communications under IEEE 802.11a standard.

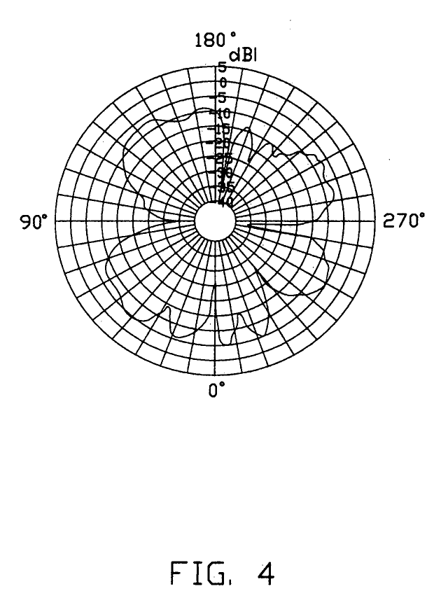

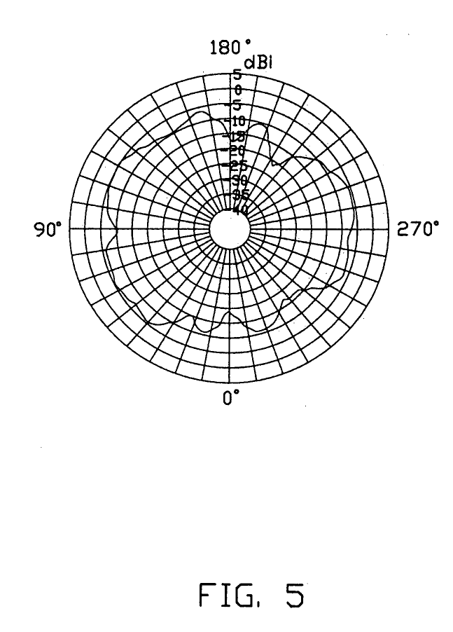

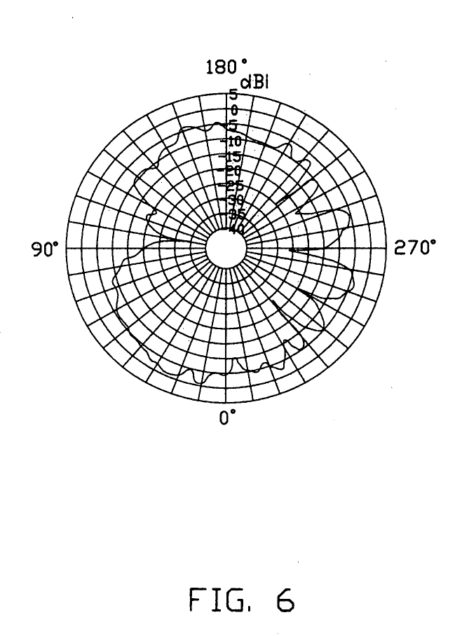

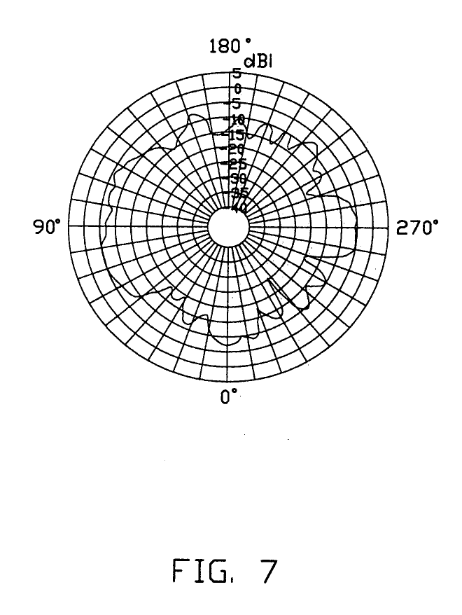

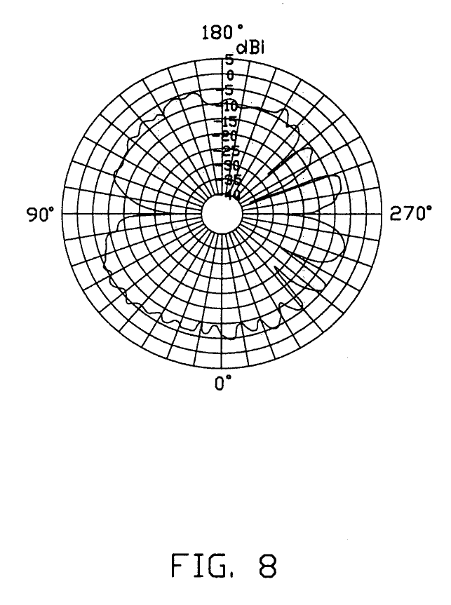

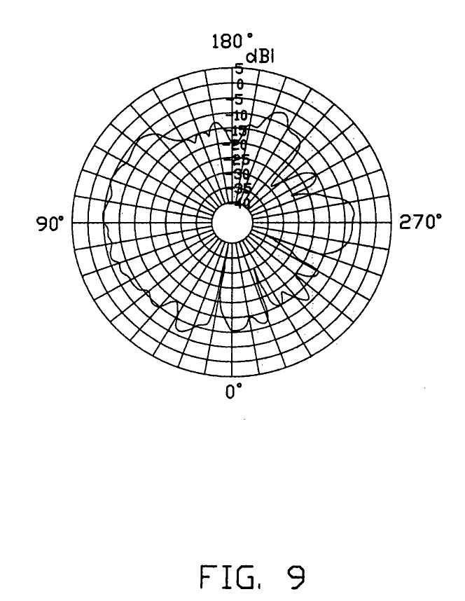

FIGS. 4-9 show the horizontally polarized and vertically polarized principle plane radiation patterns of the antenna 100 operating at the resonant frequency of 2.45 GHz, 5.25 GHz and 5.598 GHz. Note that each radiation pattern of the multi-band antenna 100 is close to corresponding optimal radiation pattern and there is no obvious radiating blind area, conforming to the practical use conditions of an antenna.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

1. A built-in antenna used with an electronic device, comprising:
a grounding portion;
a radiating portion arranged in a lengthwise direction and comprising adjacent first and second edges, the radiating portion defining at least two slots each having an open end respectively arranged on said first and second edges; and
a connecting portion connecting the radiating portion and the grounding portion.

2. The built-in antenna as claimed in claim 1, wherein the radiating portion comprises a first and a second radiating patches, the first radiating patch defines a first elongated slot inwardly extending from the first edge thereof for increasing a bandwidth of the antenna.

3. The built-in antenna as claimed in claim 2, wherein the first slot straightly extends in said lengthwise direction, a width of the first slot being much narrower than that of the radiating portion.

4. The built-in antenna as claimed in claim 3, wherein the radiating portion defines a second slot inwardly extending from a second edge thereof perpendicular to the first edge for increasing the bandwidth of the antenna.

5. The built-in antenna as claimed in claim 4, wherein the second slot comprises at least an arc-shaped slot defined in one of the first and the second radiating patches.

6. The built-in antenna as claimed in claim 5, wherein the second radiating patch defines a substantially L-shaped third slot having an opening on said second edge of the radiating portion and extending to a third edge of the radiating portion parallel to the first edge.

7. The built-in antenna as claimed in claim 1, wherein the radiating portion is arranged in a first plane parallel to the grounding portion and the connecting portion is arranged in another plane perpendicular to the grounding portion, the connecting portion being formed of metal.

8. The built-in antenna as claimed in claim 7, wherein the radiating portion is substantially rectangular shaped with perpendicular first and second edges, the slots extending from respective one of the edges and both in said lengthwise direction.

9. The built-in antenna as claimed in claim 8, wherein the connecting portion comprises a first, a second and a third connecting sections corporately forming an n-shape with a slot therein for tuning an impedance matching of the antenna.

10. An antenna used in an electronic device, comprising:
a radiating portion arranged in a first plane;
a grounding portion arranged in a second plane distant from the first plane;
a connecting portion arranged in a third plane and connecting the radiating portion and the grounding portion, the connecting portion defining a slot for tuning an impedance matching of the antenna; and
a feeder point arranged on the connecting portion.

11. The antenna as claimed in claim 10, wherein the connecting portion is made of metal sheet and comprises a first connecting section connected to the radiating portion and two substantially parallel second connecting sections connected to the grounding portion.

12. The antenna as claimed in claim 10, wherein the second plane is parallel to the first plane and the third plane is perpendicular to the first plane.

13. The antenna as claimed in claim 12, wherein the radiating portion is substantially rectangular shaped and has a plurality of edges.

14. The antenna as claimed in claim 13, wherein the radiating portion defines a plurality of slots each having an open end on a respective one of the edges of the radiating portion.

15. The antenna as claimed in claim 14, wherein the slots comprise a first slot and a second slot extending in a same direction.

16. The antenna as claimed in claim 15, wherein the first slot is elongated and the second slot is L-shaped.

17. A built-in antenna used with an electronic device, comprising:
a grounding portion;
a radiating portion defining at least two slots having different shapes and different dimensions from each other so as to form multiple bands thereof; and
a connecting portion connecting the radiating portion and the grounding portion.

18. The antenna as claimed in claim 17, wherein said connection portion is located on a plane different from that of either one of said grounding portion and said radiating portion.

19. The antenna as claimed in claim 17, wherein a feeder cable includes an inner conductor connected to the connecting portion and an outer conductor connected to the grounding portion.
